(19) United States
(12) Patent Application Publication
(10) Pub. No.: US 2026/0127098 A1
(43) Pub. Date: May 7, 2026

(54) USING MACHINE LEARNING TO PREDICT TESTS ASSOCIATED WITH APPLICATION PROGRAMMING INTERFACE UPDATES

(71) Applicant: Citibank, N.A., New York, NY (US)

(72) Inventors: Vidyalakshmi PATHAI RAMAKRISHNAN, Chennai (IN); Padmapriya NARASIMHAN, Chennai (IN); Premkumar RAJAGOPALAN, Serangoon (SG); Miriam SILVER, Herzliya (IL)

(73) Assignee: Citibank, N.A., New York, NY (US)

(21) Appl. No.: 18/940,535

(22) Filed: Nov. 7, 2024

(51) Int. Cl. G06F 11/36; G06N 20/00

(52) U.S. Cl. CPC G06F 11/368; G06F 11/3608; G06F 11/3688; G06N 20/00

(57) ABSTRACT

Systems and methods for using machine learning to predict tests for testing application programming interface updates. The system receives a prediction request to predict one or more tests for testing a candidate update to an application programming interface, wherein the prediction request comprises an indication of the application programming interface. The system may determine, using the indication of the application programming interface, a plurality of parameters associated with the application programming interface and obtain, based on the plurality of parameters using a machine learning model a prediction of a plurality of tests to be executed for the candidate update to the application programming interface. The system may determine, a first subset of the plurality of tests enabled to be executed without user input and cause the first subset of the plurality of tests to be executed without the user input.

### BACKGROUND

Software development and testing has been on the forefront of computer science for many years. Engineers have been updating computer code for various reasons including new features, bug fixes and for other suitable reasons. In many instances this computer code takes a form of an application programming interface that can be invoked to perform various tasks. In recent years, engineers have been developing more and more complex application programming interfaces (“APIs”) and it has become difficult to update those APIs and test the updates without breaking any computer code that uses those application programming interfaces. In addition, in recent years the use of artificial intelligence, including but not limited to machine learning, deep learning, etc. (referred to collectively herein as artificial intelligence), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. Thus, it may be desirable to use artificial intelligence (e.g., machine learning) to aid in properly updating APIs.

### SUMMARY

Accordingly, systems and methods are described herein for using artificial intelligence such as machine learning to predict tests for testing application programming interface updates. An API testing system may be used to perform operations described herein. For example, when developers generate updates to user interfaces, these developers may be required to test the updated APIs. However, it may be difficult to ascertain which tests should be run and who should run those tests. In some instances, the tests may be stored in two different databases and may be retrieved and displayed to a user for execution. For example, a developer database may include tests recommended by developers based on developers'knowledge of API usage. A second database may be queried that may store other candidate tests. For example, if the same API was updated in the past, those tests may be stored with the API's identifier. Thus, the API testing system may retrieve those tests and determine that those tests should be added to the testing of the API. In this case, any missed tests would be added to the testing schedule.

In some embodiments, the API testing system may use machine learning to determine which tests should be performed on the updated API. In particular, the API testing system may receive a prediction request to predict one or more tests for testing a candidate update to an application programming interface. The prediction request may include an indication of the application programming interface. For example, a developer or a team of developers may develop an update to a particular API and may submit the update to be tested. Thus, the API testing system may receive the prediction request.

When the API testing system receives the prediction request, the API testing system may determine parameters for performing the prediction. In particular, the API testing system may determine, using the indication of the application programming interface, a plurality of parameters associated with the application programming interface. In some embodiments, the parameters may be metadata associated with the API (e.g., variables, sub-routines, jurisdictions of where the API is used, and others). However, in some embodiments, the parameters may be one or more embeddings of the API code. For example, the API testing system may embed the code of the API into an embedding space of a machine learning model. In another example, the API testing system may vectorize the code of the API into a vector space of the machine learning model.

For example, the embedding model may be trained by retrieving, e.g., from a development database, a first training dataset that includes a first plurality of tests associated with a plurality of application programming interfaces, and, from a repository, a second training dataset that includes a second plurality of tests associated with the plurality of application programming interfaces. Using an embedding model trained to embed computer code into the embedding space of the machine learning model, a plurality of embeddings can be generated. In some examples, the plurality of embeddings may represent the plurality of application programming interfaces. The machine learning model may then be trained using a training dataset that includes the first training dataset, the second training dataset, and the plurality of embeddings.

The API testing system may then use the machine learning model to predict which tests should be used to test the updated API. In particular, the API testing system may input the plurality of parameters into a machine learning model to obtain a prediction of a plurality of tests to be executed for the candidate update to the application programming interface. The machine learning model may be one that has been trained to predict, based on the plurality of parameters, the prediction of the plurality of tests. That is, the machine learning model may be trained to predict which tests should be performed to test the updated API. In some embodiments, the machine learning model may be a trained neural network, or another suitable machine learning model. In yet some embodiments, the machine learning model may be a large language model that may take, as input, the code associated with the updated API and a prompt to indicate which tests should be used to test the updated API.

In some embodiments, the machine learning model may be trained using previously executed tests for previously updated APIs. For example, the API testing system may retrieve from a development database and/or other sources tests and testing routines executed for a plurality of API updates. The API testing system may also generate an embedding from each API within the API updates and input those embeddings and the tests into a training routine of the machine learning model to train the machine learning model.

When the API testing system receives the tests for testing the updated API, the API testing system may identify the type of tests that are required. In particular, the API testing system may determine, a first subset of the plurality of tests enabled to be executed without user input. For example, the API testing system may identify those tests that may be executed automatically. When the API testing system identifies those tests, the API testing system may proceed to execute those tests and collect the results. Thus, the API testing system may cause the first subset of the plurality of tests to be executed without the user input.

The API testing system may also identify tests that cannot be run automatically and may notify users or groups to run those tests. For example, the API testing system may access a database of tests which may store contact information for groups or users associated with each test. The API testing system may retrieve the contract information and may transmit a request to execute a test. In some embodiments, the request may include test metadata for running the test. The test metadata may include links to the updated API, test parameters, and/or other suitable data.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for using machine learning to predict tests for testing application programming interface updates, in accordance with one or more embodiments of this disclosure.

FIG. 2 illustrates a data structure that represents an exemplary request, e.g., to predict tests for testing application programming interface updates, in accordance with one or more embodiments of this disclosure.

FIG. 3A illustrates an exemplary representation of computer code of an application programming interface, in accordance with one or more embodiments of this disclosure.

FIG. 3B illustrates an exemplary representation of parameters associated with the application programming interface, in accordance with one or more embodiments of this disclosure.

FIG. 3C illustrates exemplary data structures for tests associated with various application programming interfaces, in accordance with one or more embodiments of this disclosure.

FIG. 4 is a block diagram of an example transformer, e.g., that can be used to predict tests for testing application programming interface updates, in accordance with one or more embodiments of this disclosure.

FIG. 5 illustrates a computing system that can be used for using machine learning to predict tests for testing application programming interface updates, in accordance with one or more embodiments of this disclosure.

FIG. 6 is a flowchart of operations for using machine learning to predict tests for testing application programming interface updates, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

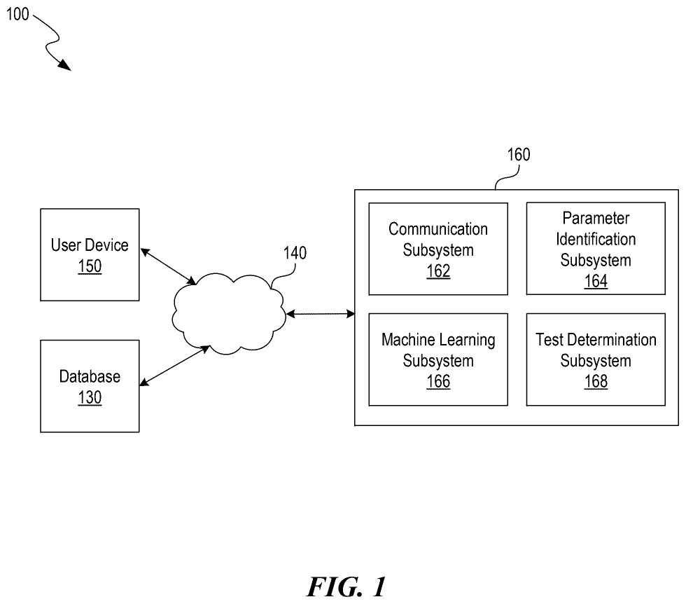

Environment 100 FIG. 1 shows an illustrative system for using machine learning to predict tests for testing application programming interface updates, in accordance with one or more embodiments of this disclosure. For example, environment 100 may be used to identify tests that are required to, or should be performed for an API, such as when a developer desires to update an API, e.g., to a new version. Environment 100 may help facilitate prediction of tests to execute for the API. For example, environment 100 may include a user device 150, through which a user may request for one or more tests to be identified for an API. The request may indicate information associated with the API (e.g., dependencies, user access information, integration requirements, etc.), which the system may utilize to identify sets of tests to be executed.

API test prediction system 160 may include software, hardware, or a combination of the two. For example, API test prediction system 160 may be a physical server or a virtual server that is running on a physical computer system. In some embodiments, API test prediction system 160 may be configured on a user device (e.g., a laptop computer, a smartphone, a desktop computer, an electronic tablet, or another suitable user device).

As described herein, the API test prediction system 160 may receive a request from a user to predict tests for testing API updates. For example, a user at the user device 150 may transmit a request using various input methods such as through touch input, keyboard input, mouse and trackpad input, voice input, gesture recognition, and/or the like. The user device may include devices such as mobile devices, computing devices, etc. In some examples, the request may be automatically generated at user device 150 when the device detects updates to an API, or attempted updates to an API. For example, a developer may update computer code for the API at the user device 150, such as to update a resource. Responsive to detecting a change or detecting an attempted republishing or redeployment of the API after the updates, the user device 150 may automatically generate and transmit a request to the API test prediction system 160 to identify tests to execute.

API test prediction system 160 may receive the request to predict the tests using a communication subsystem 162. For example, API test prediction system 160 may receive the data from a user (e.g., developer) at user device 150 via a user interface thereon through a communication network 140. Communication network 140 may be a local area network (LAN), a wide area network (WAN; e.g., the internet), or a combination of the two. Communication subsystem 162 may include software components, hardware components, or a combination of both. For example, communication subsystem 162 may include a network card (e.g., a wireless network card and/or a wired network card) that is associated with software to drive the card. Communication subsystem 162 may pass at least a portion of the data, or a pointer to the data in memory, to other subsystems such as a parameter identification subsystem 164, a machine learning subsystem 166, and test determination subsystem 168.

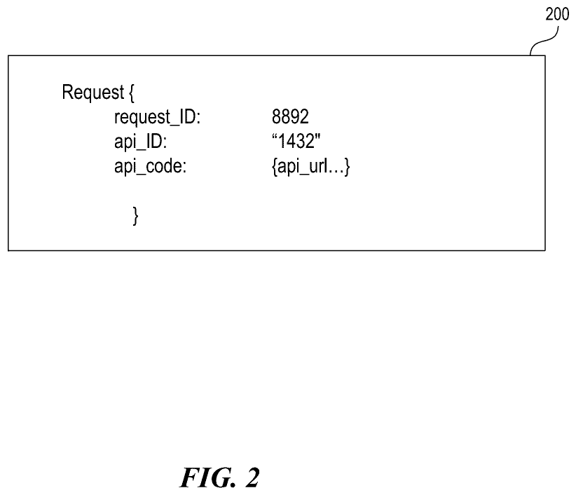

As described herein, the user may transmit a request for predictions for tests to execute for an API. For example, FIG. 2 illustrates a data structure 200 that represents an exemplary request to predict tests for testing API updates such as using machine learning, in accordance with one or more embodiments of this disclosure. The data structure 200 may be received by the API test prediction system 160 via the communication subsystem 162 through communication network 140. Data structure 200 may include one or more fields and parameters such as a field “request_ID” that includes an identifier for the specific request. In the example of FIG. 2, the request identifier is “8892”. In some examples, the data structure may not include a request identifier when received by the API test prediction system 160 and may instead be attached to the request by the API test prediction system 160 upon receiving the request.

The data structure 200 may also include an indication of the application programming interface for which testing is needed. For example, the data structure may include identifiers such as an API identifier “api_ID”, which is indicative of the API to which updates have been made and/or testing is needed. Another indication may include computer code for the API. The computer code may be configured to be executed on a server and may include the entire API program or a portion of the program.

Each of the identifiers described herein, including “api_ID” or “request_ID”, may include a string of alphanumeric characters, or a string of numeric exclusive or alphabetic exclusive identifiers. The characters may form a unique string that identifies the API at the API test prediction system 160. In some examples, the data structure 200 may further include data such as computer code associated with the API, or other information such as dependencies for the API, user access information, integration requirements, functions and subfunctions, variables, jurisdictions in which the API will be run, and/or the like. Alternatively or additionally, information associated with the API may be extracted or processed separately once received by the API test prediction system 160 and may not be part of the request.

According to some examples, the request may not include computer code for the API. Instead, the request may include an identifier (e.g., “api_ID”) and API test prediction system 160 may use the identifier to search for and access the API. In some examples, the API test prediction system 160 may transmit, e.g., via the communication subsystem 162 through communication network 140, a request for the computer code generated using the identifier to a repository or database that stores APIs. In response, the API test prediction system 160 may receive the computer code or an indication that the search failed.

Communication subsystem 162 may pass at least a portion of the request data, or a pointer to the data in memory, to parameter identification subsystem 164. The parameter identification subsystem 164 may be configured to determine, e.g., using the indication of the application programming interface, a plurality of parameters associated with the application programming interface. For example, the parameter identification subsystem 164 may obtain computer code for the API or the API identifier for the API and determine parameters using the information therein. For example, parameter identification subsystem 164 may extract data including API details, dependencies, user access information, and integration requirements. In some examples, the parameters may be obtained from parameter sources of the API (e.g., path parameters, query parameters, header parameters, body parameters, form parameters, cookie parameters, etc.).

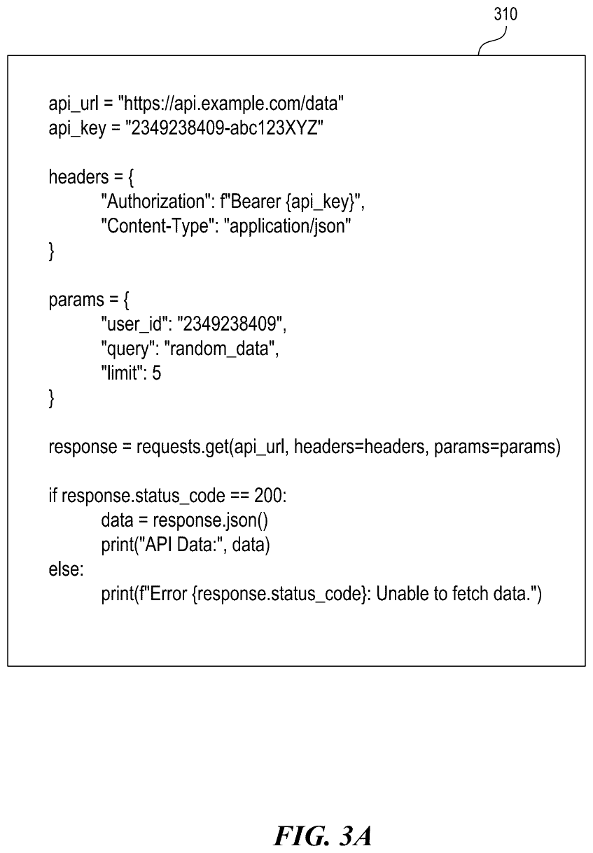

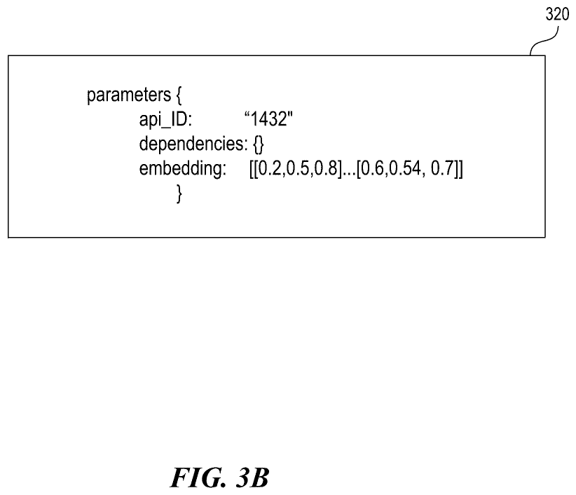

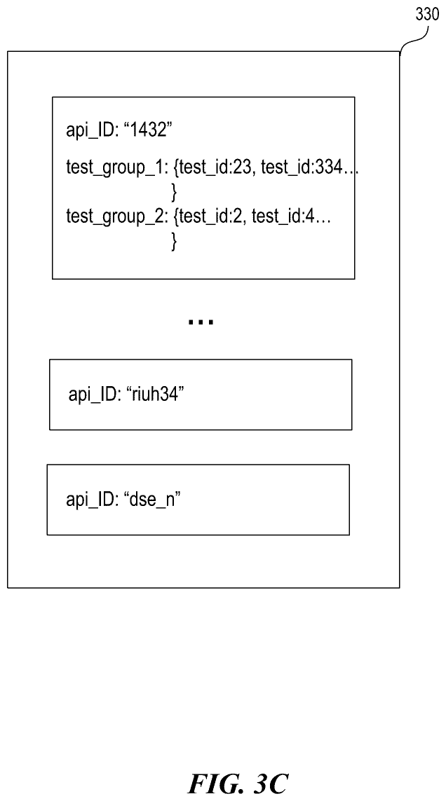

In some embodiments, determining the plurality of parameters may include receiving computer code of the API and generating an embedding of the computer code. For example, FIG. 3A shows a data structure 310 of computer code for an exemplary API. The parameter identification subsystem 164 may generate an embedding representing the application programming interface using an embedding model trained to embed the computer code into the embedding space of the machine learning model. For example, embedding models such as word2vec, global vectors for word representation, FastText, BERT, and/or the like may be used to generate embeddings (e.g., real-number vector representations where similar data points are located near each other in the vector space). Parameter identification subsystem 164 may add the generated embedding as a parameter of the plurality of parameters.

FIG. 3B illustrates an exemplary representation of parameters 320 associated with the application programming interface, in accordance with one or more embodiments of this disclosure. In the example of FIG. 3B, the parameters may include data such as the API identifier, dependencies for the API, path parameters, etc. as well as an embedding “[[0.2,0.5,0.8] . . . [0.6,0.54, 0.7]]” that represents the API computer code in vector space.

According to some embodiments, the data from the determined parameters may be cleaned and/or normalized, e.g., for consistency and to remove any noise. In some examples, a Large Language Model (LLM) and/or prompt engineering may be used as addition check/identification/correction of noise/issues. In particular, the parameter identification subsystem 164 may generate a prompt such as “Identify any missing values in the {dataset} and suggest how to handle them,” e.g., by inserting one or more parameters or a portion of parameter data into “{dataset}” to generate the prompt. Parameter identification subsystem 164 may then input the prompt into an LLM or other model to obtain a cleaned or normalized parameter set/data.

The parameter identification subsystem 164 may pass the determined parameters, or a pointer to the data in memory, to the machine learning subsystem 166. The machine learning subsystem may be configured to obtain, based on the plurality of parameters using a machine learning model, a prediction of a plurality of tests to be executed for the candidate update to the application programming interface.

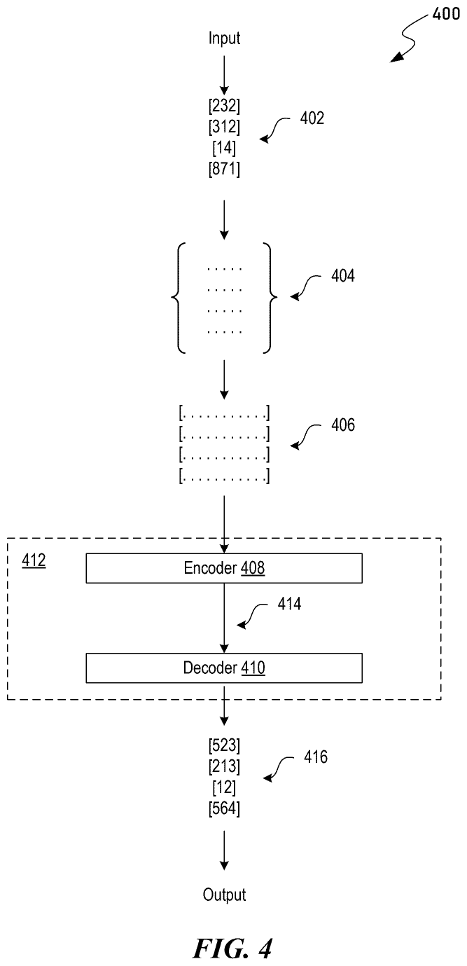

For example, the machine learning subsystem 166 may input the plurality of parameters into a machine learning model to obtain a prediction of a plurality of tests to be executed for the candidate update to the application programming interface. In some examples, the machine learning model may be trained to predict, based on the plurality of parameters embedded into an embedding space of the machine learning model, the prediction of the plurality of tests. The machine learning subsystem 166 may input the embedding into the machine learning model and receive as output, one or more tests to be executed. Exemplary machine learning models are discussed in reference to FIG. 4 herein.

The machine learning subsystem 166 may pass the output tests, or a pointer to the data in memory, to the test determination subsystem 168. The test determination subsystem 168 may be configured to determine different subsets of tests. For example, the test determination subsystem 168 may be configured to determine a first subset of the plurality of tests enabled to be executed without user input and/or a second subset of the plurality of tests that are not enabled to be executed without the user input. In some examples, this determination may be based on an estimated length of test run-time. For example, if a test takes several days to run, the system may notify a user and attempt to gain permission to execute the test because a user may prefer to forgo the test because the API is needed. Other reasons may include high resource cost, usage of sensitive data, restricted access, if tests require human judgment such as checking visual outputs, concurrency issues (e.g., some tests may fail when executed in parallel with others due to shared resources), and/or the like.

The system may then cause the first subset of the plurality of tests to be executed, e.g., without the user input. The system may additionally cause the second subset of the plurality of tests to be presented to the user, e.g., via user device 150. Responsive to an indication or interaction of the user at the user device indicating to execute the test, the test may be executed.

The API test prediction system 160 and/or user device may obtain, for example, an indication that the test(s) were executed successfully. If any anomalies are detected or test failures occur, the API test prediction system 160 may transmit to the user device, e.g., via communication subsystem 162, a message to notify the user of anomalous behavior and test failures. In some cases, the system may also provide suggestions for corrections, e.g., modifications to the API computer code to improve or enable the API to pass the test(s).

Responsive to an indication that one or more tests were executed, API test prediction system 160 may add the test(s) and information identifying the corresponding API into a database for use later on. For example, FIG. 3C is an exemplary figure of subsets of tests for various APIs. In some examples, a database, such as database 130 may store previous tests performed for various APIs. The API test prediction system 160 may retrieve, such as via communication subsystem 162, a corresponding plurality of tests for a plurality of application programming interfaces, wherein each corresponding plurality of tests were performed on a corresponding application programming interface. In the example of FIG. 3C, the database 330 stores different data structures corresponding to APIs and associated tests that were performed. For example, the first data structure for an API having API identifier “1432” stores data indicating the tests that were performed, including an indication as to which tests were in “test_group_1” and indicated to be executed without user input and which are in “test_group_2.” In some cases, the database may also store API documentation and code (e.g., in embedded vector format).

According to some examples, the machine learning model may be an LLM. In this example, the system may generate a prompt based on the parameters and leverage the database of FIG. 3C or a different database storing API documentation and code (e.g., in embedded vector format) to enrich the prompt. For example, API test prediction system 160 may generate a first portion of a prompt for the machine learning model that includes a command to use the plurality of application programming interfaces and each corresponding plurality of tests to inform a response from the machine learning model.

For example, API test prediction system 160 may use pre-trained transformer models for understanding and processing natural language in API documentation and may implement Retrieval-Augmented Generation (RAG) with vector search for quick retrieval of relevant information and dependencies. The API test prediction system 160 may search, using the vector embedding of the computer code, similar computer code or API documentation from the database to identify relevant information and dependencies. The system may implement vector search such as in a large vector collection, e.g., using Facebook AI Similarity Search) to quickly search through the database for relevant information and dependencies. The content retrieved as a result may then be used to enrich LLM prompting.

As an example, the API test prediction system 160 may use RAG endpoints that utilize vector-based retrieval like FAISS to retrieve data on all APIs that a particular service depends on or is depended upon. In one example, the retrieval process may be used to identify that an API “UserService” depends on “AuthService” and “NotificationService”.

The system may generate a second portion of the prompt for the machine learning model based on the application programming interface as described herein. For example, the second portion of the prompt may include the computer code, the parameters, and/or the like. The prompt may then be input into the large language model. In this way, the prompt may provide more context to the LLM regarding information about the API, so that the LLM may provide more context-specific information (e.g., prediction for tests).

According to some embodiments, the LLM may be integrated with external APIs to enable a Reasoning and Acting (ReAct) framework. The ReAct framework may enable the system to reason about the query and takes actions based on the reasoning. An example prompt structure for the ReAct framework may include “Analyze the given API information and user access details. Identify any missing dependencies or incorrect user permissions and suggest actions to correct them.”

In some examples, the tests are executed locally on the API test prediction system 160. Alternatively or additionally, the tests may be executed on a remote device or the user device 150. For example, the test determination subsystem 168 may pass the tests or data identifying the tests to the communication subsystem 162. The communication subsystem 162 may then transmit the tests or data identifying the tests to another device, where the tests may be executed.

According to some examples, the tests that are identified by the machine learning subsystem may be stored locally and transmitted or executed thereon. In other examples, the tests may be identified, but not stored locally, and the test determination subsystem 168 may transmit a request to obtain the tests at a database or repository.

According to some embodiments, a user, such as a developer, at the user device 150 may determine that a test is missing from the prediction of the plurality of tests. The user may transmit a request or message to the API test prediction system 160 which may identify the missing test(s). The API test prediction system 160 may receive the message indicating that a test is missing from the prediction via communication subsystem 162, e.g., through communication network 140. The API test prediction system may then generate an updated plurality of tests by adding the test that is missing to the plurality of tests and generate an updated embedding from the API. As described herein, various different embedding techniques can be used to generate the embedding. The machine learning subsystem 166 may be used to input the updated embedding and the updated plurality of tests into a training routine of the machine learning model to improve the machine learning model.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 4 is a block diagram 400 of an example transformer 412 that may be used to predict one or more tests for testing APIs, according to some embodiments. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 412 includes an encoder 408 (which can include one or more encoder layers/blocks connected in series) and a decoder 410 (which can include one or more decoder layers/blocks connected in series). Generally, the encoder 408 and the decoder 410 each include multiple neural network layers, at least one of which can be a self-attention layer. The parameters of the neural network layers can be referred to as the parameters of the language model.

The transformer 412 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 412 is trained to perform certain functions on other input formats than natural language input. For example, the input can include objects, images, audio content, or video content, or a combination thereof.

The transformer 412 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 4 illustrates an example of how the transformer 412 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 4, a short sequence of tokens 402 corresponding to the input text is illustrated as input to the transformer 412. Tokenization of the text sequence into the tokens 402 can be performed by some pre-processing tokenization module such as, for example, a byte-pair encoding tokenizer (the “pre” referring to the tokenization occurring prior to the processing of the tokenized input by the LLM), which is not shown in FIG. 4 for brevity. In general, the token sequence that is inputted to the transformer 412 can be of any length up to a maximum length defined based on the dimensions of the transformer 412. Each token 402 in the token sequence is converted into an embedding vector 406 (also referred to as “embedding 406”).

An embedding 406 is a learned numerical representation (such as, for example, a vector) of a token that captures some semantic meaning of the text segment represented by the token 402. The embedding 406 represents the text segment corresponding to the token 402 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 406 corresponding to the “write” token will be closer to another embedding corresponding to the “jot down” token in the vector space as compared to the distance between the embedding 406 corresponding to the “write” token and another embedding corresponding to the “summary” token.

The vector space can be defined by the dimensions and values of the embedding vectors. Various techniques can be used to convert a token 402 to an embedding 406. For example, another trained ML model can be used to convert the token 402 into an embedding 406. In particular, another trained ML model can be used to convert the token 402 into an embedding 406 in a way that encodes additional information into the embedding 406 (e.g., a trained ML model can encode positional information about the position of the token 402 in the text sequence into the embedding 406). In some implementations, the numerical value of the token 402 can be used to look up the corresponding embedding in an embedding matrix 404, which can be learned during training of the transformer 412.

The generated embeddings 406 are input into the encoder 408. The encoder 408 serves to encode the embeddings 406 into feature vectors 414 that represent the latent features of the embeddings 406. The encoder 408 can encode positional information (i.e., information about the sequence of the input) in the feature vectors 414. The feature vectors 414 can have very high dimensionality (e.g., on the order of thousands or tens of thousands), with each element in a feature vector 414 corresponding to a respective feature. The numerical weight of each element in a feature vector 414 represents the importance of the corresponding feature. The space of all possible feature vectors 414 that can be generated by the encoder 408 can be referred to as a latent space or feature space.

Conceptually, the decoder 410 is designed to map the features represented by the feature vectors 414 into meaningful output, which can depend on the task that was assigned to the transformer 412. For example, if the transformer 412 is used for a translation task, the decoder 410 can map the feature vectors 414 into text output in a target language different from the language of the original tokens 402. Generally, in a generative language model, the decoder 410 serves to decode the feature vectors 414 into a sequence of tokens. The decoder 410 can generate output tokens 416 one by one. Each output token 416 can be fed back as input to the decoder 410 in order to generate the next output token 416.

By feeding back the generated output and applying self-attention, the decoder 410 can generate a sequence of output tokens 416 that has sequential meaning (e.g., the resulting output text sequence is understandable as a sentence and obeys grammatical rules). The decoder 410 can generate output tokens 416 until a special [EOT] token (indicating the end of the text) is generated. The resulting sequence of output tokens 416 can then be converted to a text sequence in post-processing. For example, each output token 416 can be an integer number that corresponds to a vocabulary index. By looking up the text segment using the vocabulary index, the text segment corresponding to each output token 416 can be retrieved, the text segments can be concatenated together, and the final output text sequence can be obtained.

In some implementations, the input provided to the transformer 412 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Exemplary Computer System

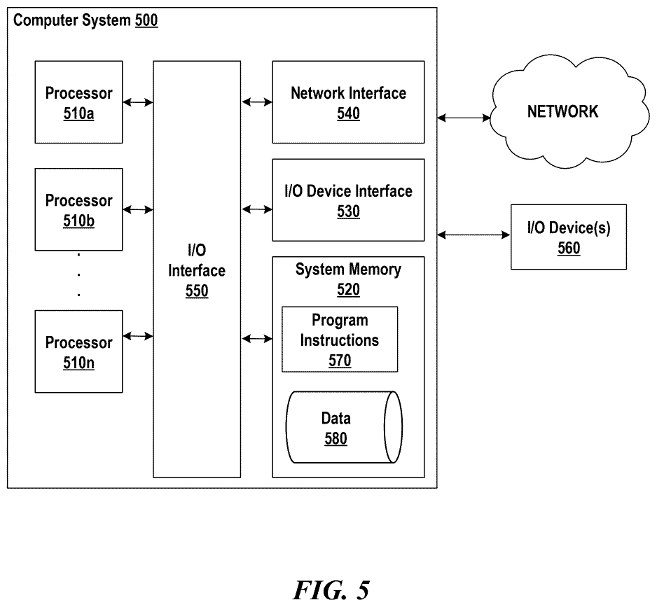

FIG. 5 shows an example computing system that may be used in accordance with some embodiments of this disclosure. In some instances, computing system 500 is referred to as a computer system 500. A person skilled in the art would understand that those terms may be used interchangeably. The components of FIG. 5 may be used to perform some or all operations discussed in relation to FIGS. 1-4. Furthermore, various portions of the systems and methods described herein may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output (I/O) device interface 530, and a network interface 540 via an I/O interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 500. A processor may execute code (e.g., processor firmware, a protocol stack, a database management system, an operating system, or a combination thereof) that creates an execution environment for program instructions.

A processor may include a programmable processor. A processor may include general or special purpose microprocessors. A processor may receive instructions and data from a memory (e.g., system memory 520). Computing system 500 may be a uni-processor system including one processor (e.g., processor 510a), or a multiprocessor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 500 may include a plurality of computing devices (e.g., distributed computer systems) to implement various processing functions.

I/O device interface 530 may provide an interface for connection of one or more I/O devices 560 to computer system 500. I/O devices may include devices that receive input (e.g., from a user) or output information (e.g., to a user). I/O devices 560 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computer system 500 through a wired or wireless connection. I/O devices 560 may be connected to computer system 500 from a remote location. I/O devices 560 located on remote computer systems, for example, may be connected to computer system 500 via a network and network interface 540.

The I/O device interface 530 and I/O devices 560 may be used to enable manipulation of the three-dimensional model as well. For example, the user may be able to use I/O devices such as a keyboard and touchpad to indicate specific selections for nodes, adjust values for nodes, select from the history of machine learning models, select specific inputs or outputs, and/or the like. Alternatively or additionally, the user may use their voice to indicate specific nodes, specific models, and/or the like via the voice recognition device and/or microphones.

Network interface 540 may include a network adapter that provides for connection of computer system 500 to a network. Network interface 540 may facilitate data exchange between computer system 500 and other devices connected to the network. Network interface 540 may support wired or wireless communication. The network may include an electronic communication network, such as the internet, a LAN, a WAN, a cellular communications network, or the like.

System memory 520 may be configured to store program instructions 570 or data 580. Program instructions 570 may be executable by a processor (e.g., one or more of processors 510a-510n) to implement one or more embodiments of the present techniques. Program instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 520 may include a non-transitory, computer-readable storage medium that may have program instructions stored thereon that are executable by a computer processor (e.g., one or more of processors 510a-510n) to cause the subject matter and the functional operations described herein. A memory (e.g., system memory 520) may include a single memory device and/or a plurality of memory devices (e.g., distributed memory devices).

I/O interface 550 may be configured to coordinate I/O traffic between processors 510a-510n, system memory 520, network interface 540, I/O devices 560, and/or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 500 or multiple computer systems 500 configured to host different portions or instances of embodiments. Multiple computer systems 500 may provide for parallel or sequential processing/execution of one or more portions of the techniques described herein.

Those skilled in the art will appreciate that computer system 500 is merely illustrative and is not intended to limit the scope of the techniques described herein. Computer system 500 may include any combination of devices or software that may perform or otherwise provide for the performance of the techniques described herein. For example, computer system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 500 may also be connected to other devices that are not illustrated or may operate as a stand-alone system. In addition, the functionality provided by the illustrated components may, in some embodiments, be combined in fewer components, or be distributed in additional components. Similarly, in some embodiments, the functionality of some of the illustrated components may not be provided, or other additional functionality may be available.

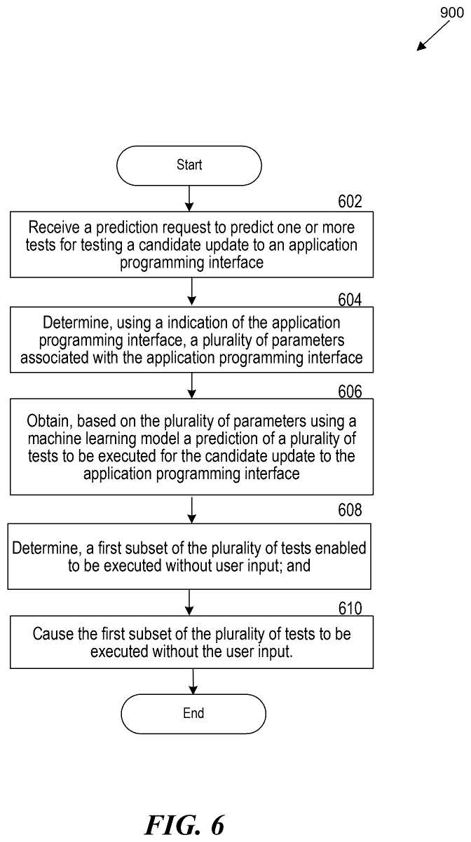

FIG. 6 is a flowchart of operations for using machine learning to predict tests for testing application programming interface updates, in accordance with one or more embodiments of this disclosure. The operations of FIG. 6 may use components described in relation to FIG. 5. In some embodiments, API test prediction system 160 may include one or more components of computer system 500.

At operation 602, one or more of processors 510a-510n receives a prediction request to predict one or more tests for testing a candidate update to an application programming interface. For example, API test prediction system 160 may use one or more processors 510a, 510b, and/or 510n to perform the receiving. The processor(s) may receive the request from a user device. One or more of processors 510a-510n may receive the data over communication network 140 using network interface 540.

According to some embodiments, the request may be automatically generated and/or transmitted by the user device responsive to detecting an update or attempt to redeploy the API after change. The request may include an indication of the API, such as computer code of the API, or the API identifier, from which computer code may be accessed.

At operation 604, one or more of processors 510a-510n determine, using an indication of the application programming interface, a plurality of parameters associated with the application programming interface. As described herein, the parameters may include metadata associated with the API (e.g., variables, sub-routines, jurisdictions of where the API is used, and others). However, in some embodiments, the parameters may be one or more embeddings of the API code. For example, the API testing system may embed the code of the API into an embedding space of a machine learning model.

At operation 606, one or more of processors 510a-510n obtain, based on the plurality of parameters using a machine learning model a prediction of a plurality of tests to be executed for the candidate update to the application programming interface. In some examples, one or more of processors 510a-510n may input the plurality of parameters into a machine learning model to obtain a prediction of a plurality of tests to be executed for the candidate update to the application programming interface. The machine learning model may be trained to predict, based on the plurality of parameters embedded into an embedding space of the machine learning model, the prediction of the plurality of tests.

At operation 608, one or more of processors 510a-510n may be used to determine a first subset of the plurality of tests enabled to be executed without user input. The processor(s) may also be used to determine a second subset of tests that are not enabled to be executed without the user input. For example, the system may determine whether or not a test can be executed without user input based on factors for the tests including resource cost, usage of sensitive data, restricted access, if tests require human judgment such as checking visual outputs, concurrency issues (e.g., some tests may fail when executed in parallel with others due to shared resources), and/or the like.

At operation 610, one or more of processors 510a-510n may cause the first subset of the plurality of tests to be executed without the user input. As described herein, the one or more processors can be used to transmit an instruction to cause the test(s) to be executed at a remote device, e.g., server. Alternatively or additionally, the one or more processors may cause the test(s) to be executed locally.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for using machine learning to predict tests for testing application programming interface updates, the method comprising: receiving a prediction request to predict one or more tests for testing a candidate update to an application programming interface, wherein the prediction request comprises an indication of the application programming interface; determining, using the indication of the application programming interface, a plurality of parameters associated with the application programming interface, wherein the plurality of parameters is obtained from one or more parameter sources; inputting the plurality of parameters into a machine learning model to obtain a prediction of a plurality of tests to be executed for the candidate update to the application programming interface, wherein the machine learning model has been trained to predict, based on the plurality of parameters embedded into an embedding space of the machine learning model, the prediction of the plurality of tests; determining, a first subset of the plurality of tests enabled to be executed without user input and a second subset of the plurality of tests that are not enabled to be executed without the user input; and causing the first subset of the plurality of tests to be executed without the user input.
2. A method for using machine learning to predict tests for testing application programming interface updates, the method comprising: receiving a prediction request to predict one or more tests for testing a candidate update to an application programming interface, wherein the prediction request comprises an indication of the application programming interface; determining, using the indication of the application programming interface, a plurality of parameters associated with the application programming interface; obtain, based on the plurality of parameters using a machine learning model a prediction of a plurality of tests to be executed for the candidate update to the application programming interface; determining, a first subset of the plurality of tests enabled to be executed without user input; and causing the first subset of the plurality of tests to be executed without the user input.
3. The method of the preceding embodiment, wherein determining the plurality of parameters associated with the application programming interface further cause the one or more processors to perform operations comprising: receiving computer code of the application programming interface; generating, using an embedding model trained to embed the computer code into the embedding space of the machine learning model, an embedding representing the application programming interface; and adding the embedding as a parameter of the plurality of parameters.
4. The method of the preceding embodiment, wherein inputting the plurality of parameters into the machine learning model to obtain the prediction of the plurality of tests further cause the one or more processors to input the embedding into the machine learning model.
5. The method of any of the preceding embodiments, further comprising: retrieving, from a development database, a first training dataset comprising a first plurality of tests associated with a plurality of application programming interfaces, and, from a repository, a second training dataset comprising a second plurality of tests associated with the plurality of application programming interfaces; generating, using an embedding model trained to embed computer code into the embedding space of the machine learning model, a plurality of embeddings representing the plurality of application programming interfaces; and training the machine learning model using a training dataset comprising the first training dataset, the second training dataset, and the plurality of embeddings.
6. The method of any of the preceding embodiments, further comprising: retrieving, for a plurality of application programming interfaces, a corresponding plurality of tests, wherein each corresponding plurality of tests were performed on a corresponding application programming interface; generating a first portion of a prompt for the machine learning model that includes a command to use the plurality of application programming interfaces and each corresponding plurality of tests to inform a response from the machine learning model, wherein the machine learning model is a large language model; generating a second portion of the prompt for the machine learning model based on the application programming interface; and inputting the prompt into the large language model.
7. The method of any of the preceding embodiments, wherein receiving a message indicating that a test is missing from the prediction of the plurality of tests; generating an updated plurality of tests based on adding the test that is missing to the plurality of tests; generating an updated embedding from the application programming interface; and inputting the updated embedding and the updated plurality of tests into a training routine of the machine learning model to improve the machine learning model.
8. One or more tangible, non-transitory, computer-readable media storing instructions that, when executed by a data processing apparatus, cause the data processing apparatus to perform operations comprising those of any of embodiments 1-7.
9. A system comprising: one or more processors; and memory storing instructions that, when executed by the one or more processors, cause the processors to effectuate operations comprising those of any of embodiments 1-7.
10. A system comprising means for performing any of embodiments 1-7.
11. A system comprising cloud-based circuitry for performing any of embodiments 1-7.

1. A system for using machine learning to predict tests for testing application programming interface updates, the system comprising:
one or more processors; and
one or more memories configured to store instructions that when executed by the one or more processors perform operations comprising:
receiving a prediction request to predict one or more tests for testing a candidate update to an application programming interface, wherein the prediction request comprises at least one identifier of the application programming interface;
determining, using the at least one identifier of the application programming interface, a plurality of parameters associated with the application programming interface, wherein the plurality of parameters is obtained from one or more parameter sources;
retrieving, by querying a retrieval-augmented generation (RAG) system using at least one of the plurality of parameters, data corresponding to one or more potential dependencies of the application programming interface;
inputting (a) the plurality of parameters and (b) the data corresponding to the one or more potential dependencies into a machine learning model to obtain a prediction of a plurality of tests to be executed for the candidate update to the application programming interface, wherein the machine learning model has been trained to predict, based on the plurality of parameters embedded into an embedding space of the machine learning model, the prediction of the plurality of tests;
receiving, from the machine learning model, the plurality of tests as an output;
determining, based on run-time parameters of each test of the plurality of tests, a first subset of the plurality of tests enabled to be executed without user input and a second subset of the plurality of tests that are not enabled to be executed without the user input, wherein each run-time parameter is related to execution of a corresponding test of the plurality of tests; and
executing the first subset of the plurality of tests without the user input.

2. The system of claim 1, wherein the instructions for determining the plurality of parameters associated with the application programming interface further cause the one or more processors to perform operations comprising:
receiving computer code of the application programming interface;
generating, using an embedding model trained to embed the computer code into the embedding space of the machine learning model, an embedding representing the application programming interface; and
adding the embedding as a parameter of the plurality of parameters.

3. The system of claim 2, wherein the instructions for inputting the plurality of parameters into the machine learning model to obtain the prediction of the plurality of tests further cause the one or more processors to input the embedding into the machine learning model.

4. The system of claim 1, wherein the instructions further cause the one or more processors to perform operations comprising:
retrieving, from a development database, a first training dataset comprising a first plurality of tests associated with a plurality of application programming interfaces, and, from a repository, a second training dataset comprising a second plurality of tests associated with the plurality of application programming interfaces;
generating, using an embedding model trained to embed computer code into the embedding space of the machine learning model, a plurality of embeddings representing the plurality of application programming interfaces; and
training the machine learning model using a training dataset comprising the first training dataset, the second training dataset, and the plurality of embeddings.

5. The system of claim 1, wherein the instructions further cause the one or more processors to perform operations comprising:
retrieving, for a plurality of application programming interfaces, a corresponding plurality of tests, wherein each corresponding plurality of tests were performed on a corresponding application programming interface;
generating a first portion of a prompt for the machine learning model that includes a command to use the plurality of application programming interfaces and each corresponding plurality of tests to inform a response from the machine learning model, wherein the machine learning model is a large language model;
generating a second portion of the prompt for the machine learning model based on the application programming interface; and
inputting the prompt into the large language model.

6. The system of claim 1, wherein the instructions further cause the one or more processors to perform operations comprising:
receiving a message indicating that a test is missing from the prediction of the plurality of tests;
generating an updated plurality of tests based on adding the test that is missing to the plurality of tests;
generating an updated embedding from the application programming interface; and
inputting the updated embedding and the updated plurality of tests into a training routine of the machine learning model to improve the machine learning model.

7. A method for using machine learning to predict tests for testing application programming interface updates, the method comprising:
receiving a prediction request to predict one or more tests for testing a candidate update to an application programming interface, wherein the prediction request comprises at least one identifier of the application programming interface;
determining, using the at least one identifier of the application programming interface, a plurality of parameters associated with the application programming interface;
retrieving, by querying a retrieval-augmented generation (RAG) system using at least one of the plurality of parameters, data corresponding to one or more potential dependencies of the application programming interface;
inputting (a) the plurality of parameters and (b) the data corresponding to the one or more potential dependencies into a machine learning model to obtain a prediction of a plurality of tests to be executed for the candidate update to the application programming interface, wherein the machine learning model has been trained to predict, based on the plurality of parameters, the prediction of the plurality of tests;
receiving, from the machine learning model, the plurality of tests as an output;
determining, based on run-time parameters of each test of the plurality of tests, a first subset of the plurality of tests enabled to be executed without user input, wherein each run-time parameter is related to execution of a corresponding test of the plurality of tests;
determining, based on run-time parameters of each test, a second subset of the plurality of tests that are not enabled to be executed without user input; and
executing the first subset of the plurality of tests without the user input and notifying one or more users of the second subset of the plurality of tests.

8. The method of claim 7, wherein the plurality of parameters is embedded into an embedding space of the machine learning model using an embedding model.

9. The method of claim 7, wherein determining the plurality of parameters associated with the application programming interface further comprises:
receiving computer code of the application programming interface;
generating, using an embedding model trained to embed the computer code into an embedding space of the machine learning model, an embedding representing the application programming interface; and
adding the embedding as a parameter of the plurality of parameters.

10. The method of claim 9, wherein inputting the plurality of parameters into the machine learning model to obtain the prediction of the plurality of tests further comprises inputting the embedding of the application programming interface into the machine learning model.

11. The method of claim 7, further comprising:
retrieving, from a development database, a first training dataset comprising a first plurality of tests associated with a plurality of application programming interfaces, and, from a repository, a second training dataset comprising a second plurality of tests associated with the plurality of application programming interfaces;
generating, using an embedding model trained to embed computer code into an embedding space of the machine learning model, a plurality of embeddings representing the plurality of application programming interfaces; and
training the machine learning model using a training dataset comprising the first training dataset, the second training dataset, and the plurality of embeddings.

12. The method of claim 7, further comprising:
retrieving, for a plurality of application programming interfaces, a corresponding plurality of tests, wherein each corresponding plurality of tests were performed on a corresponding application programming interface;
generating a first portion of a prompt for the machine learning model that includes a command to use the plurality of application programming interfaces and each corresponding plurality of tests to inform a response from the machine learning model, wherein the machine learning model is a large language model;
generating a second portion of the prompt for the machine learning model based on the application programming interface; and
inputting the prompt into the large language model.

13. The method of claim 7, further comprising:
receiving a message indicating that a test is missing from the prediction of the plurality of tests;
generating an updated plurality of tests based on adding the test that is missing to the plurality of tests;
generating an updated embedding from the application programming interface; and
inputting the updated embedding and the updated plurality of tests into a training routine of the machine learning model to improve the machine learning model.

14. One or more non-transitory, computer-readable media for providing user interfaces using artificial intelligence, storing instructions thereon that cause one or more processors to perform operations comprising:
receiving a prediction request to predict one or more tests for testing a candidate update to an application programming interface, wherein the prediction request comprises at least one identifier of the application programming interface;
determining, using the at least one identifier of the application programming interface, a plurality of parameters associated with the application programming interface;
retrieving, by querying a retrieval-augmented generation (RAG) system using at least one of the plurality of parameters, data corresponding to one or more potential dependencies of the application programming interface;
obtaining, based on (a) the plurality of parameters and (b) the data corresponding to the one or more potential dependencies and using a machine learning model, a prediction of a plurality of tests to be executed for the candidate update to the application programming interface;
receiving, from the machine learning model, the plurality of tests as an output;
determining, based on run-time parameters of each test of the plurality of tests, a first subset of the plurality of tests enabled to be executed without user input, wherein each run-time parameter is related to execution of a corresponding test of the plurality of tests;
determining, based on run-time parameters of each test, a second subset of the plurality of tests that are not enabled to be executed without user input; and
executing the first subset of the plurality of tests without the user input and notifying one or more users of the second subset of the plurality of tests.

15. The one or more non-transitory, computer-readable media of claim 14, wherein instructions further cause the one or more processors to embed the plurality of parameters into an embedding space of the machine learning model using an embedding model.

16. The one or more non-transitory, computer-readable media of claim 14, wherein the instructions for determining the plurality of parameters associated with the application programming interface further cause the one or more processors to perform operations comprising:
receiving computer code of the application programming interface;
generating, using an embedding model trained to embed the computer code into an embedding space of the machine learning model, an embedding representing the application programming interface; and
adding the embedding as a parameter of the plurality of parameters.

17. The one or more non-transitory, computer-readable media of claim 16, wherein the instructions for inputting the plurality of parameters into the machine learning model to obtain the prediction of the plurality of tests further cause the one or more processors to input the embedding of the application programming interface into the machine learning model.

18. The one or more non-transitory, computer-readable media of claim 14, wherein the instructions further cause the one or more processors to perform operations comprising:
retrieving, from a development database, a first training dataset comprising a first plurality of tests associated with a plurality of application programming interfaces, and, from a repository, a second training dataset comprising a second plurality of tests associated with the plurality of application programming interfaces;
generating, using an embedding model trained to embed computer code into an embedding space of the machine learning model, a plurality of embeddings representing the plurality of application programming interfaces; and
training the machine learning model using a training dataset comprising the first training dataset, the second training dataset, and the plurality of embeddings.

19. The one or more non-transitory, computer-readable media of claim 14, wherein the instructions further cause the one or more processors to perform operations comprising:
retrieving, for a plurality of application programming interfaces, a corresponding plurality of tests, wherein each corresponding plurality of tests were performed on a corresponding application programming interface;
generating a first portion of a prompt for the machine learning model that includes a command to use the plurality of application programming interfaces and each corresponding plurality of tests to inform a response from the machine learning model, wherein the machine learning model is a large language model;
generating a second portion of the prompt for the machine learning model based on the application programming interface; and
inputting the prompt into the large language model.

20. The one or more non-transitory, computer-readable media of claim 14, wherein the instructions further cause the one or more processors to perform operations comprising:
receiving a message indicating that a test is missing from the prediction of the plurality of tests;
generating an updated plurality of tests based on adding the test that is missing to the plurality of tests;
generating an updated embedding from the application programming interface; and
inputting the updated embedding and the updated plurality of tests into a training routine of the machine learning model to improve the machine learning model.
